(19) United States
(12) Patent Application Publication
(10) Pub. No.: US 2003/0063460 A1
(43) Pub. Date: Apr. 3, 2003

(54) Device and method for illuminating liquid containers internally

(75) Inventor: Craig Nadel, Montville, NJ (US)

Correspondence Address: COHEN, PONTANI, LIEBERMAN & PAVANE, 551 FIFTH AVENUE, SUITE 1210, NEW YORK, NY, 10176, US

(73) Assignee: Craig P. Nadel

(21) Appl. No.: 10/261,269

(22) Filed: Sep. 30, 2002

Related U.S. Application Data
(60) Provisional application No. 60/325,940, filed on Sep. 28, 2001.

(51) Int. Cl. F21V 33/00; F21V 9/12

(52) U.S. Cl. 362/101; 362/318; 362/276

(57) ABSTRACT

A light chip comprised of a liquid-tight translucent casing containing at least one selectively illuminatible light source and at least one energy source is disclosed. To provide a decorative lighting effect, the light chip may be placed inside a liquid container to float freely in the contained liquid, affixed to a portion of a container, or restrained by some means to a portion of a container where it may move freely.

### RELATED APPLICATIONS

This application claims priority from U.S. Provisional Patent Application Serial No. 60/325,940 which was filed on Sep. 28, 2001 and which is hereby incorporated by reference.

### BACKGROUND OF THE INVENTION

1. Field of the Invention

The present invention relates generally to an apparatus for illuminating a substantially translucent fluid in a substantially clear container.

2. Description of the Related Art

The use of lighting to decorate and beautify objects is a long- and well-known art. From Christmas tree lights to the colored lights atop many skyscrapers, light has the unique ability to make everyday objects appear “special”.

One example of the use of light as both illumination source and decoration is shown in U.S. Pat. No. 6,332,282 to Lin (hereinafter referred to as “Lin”), entitled “Lamp Showing Movable Floating Ornaments”. Lin's lamp is a fairly complicated affair comprising a cylindrical container filled with a clear liquid and multiple floating ornaments in the shape of fish. A propeller located in the bottom of the cylinder causes the translucent liquid to move, thereby causing the fish ornaments to move. This “dynamic scene” of the fish moving about in the fluid is lit by a light located at the top of the container.

Another example of decorative light is shown in U.S. Pat. No. 6,352,352 to Schletterer et al. (hereinafter referred to as “Schletterer”), entitled “Luminiscent Container with Quick-Charging Power Source”. Schletterer is directed to a drinking glass with a Light Emitting Diode (LED) embedded in the bottom of the glass. Thus, when the Schletterer glass is manufactured, the glass must be created with a notch in which a light source needs to be positioned and sealed. The LED is powered by capacitors which are charged by an outside power source.

The examples above illustrate a lack in the prior art. The Lin lamp is manufactured for the purpose of decoration, which somewhat overwhelms its utilitarian purpose of lighting. The Schletterer glass can efficiently perform its utilitarian purpose of holding liquids for a person to consume, but the simple process of manufacturing a glass is made much more complex by the addition of an integrated LED.

There is accordingly a need for a device, system, and/or method for simply and easily applying decorative illumination and illumination effects to everyday household and consumer liquid containers, without having to drastically alter the manufacturing process.

### SUMMARY OF THE INVENTION

A primary object of the present invention is to provide a device and system for illuminating a translucent liquid hold in a container with at least one clear surface for viewing the translucent liquid.

Another object of the present invention is to provide a device and system for applying decorative light inside of common consumer translucent liquid containers, such as shampoo bottles, nail polish bottles, cosmetic containers, etc.

These and other objects are met by the present invention which provides a light chip that contains at least one light source and at least one energy source sealed in a translucent casing.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is an exploded view of the parts of a light chip according to a preferred embodiment of the present invention;

FIG. 2 is a cross-section of a first exemplary embodiment according to the present invention;

FIG. 3 a cross-section of a second exemplary embodiment according to the present invention;

FIG. 4 is a cross-section of a third exemplary embodiment according to the present invention;

FIG. 5 is a cross-section of a fourth exemplary embodiment according to the present invention;

FIG. 6 is a cross-section of a fifth exemplary embodiment according to the present invention; and

FIG. 7 is a cross-section of a sixth exemplary embodiment according to the present invention.

### DETAILED DESCRIPTION OF THE PRESENTLY PREFERRED EMBODIMENTS

The present invention is directed to a “light chip”, in preferred forms a small sealed module containing a power source and an actuatible light source. This light chip can be easily placed inside a liquid container in order to illuminate and decorate the liquid contents thereof. The light chip may either sit or float freely in the liquid or be attached to one of the surfaces of the liquid container. As an example, the light chip can be placed in the shampoo inside a shampoo bottle, thereby bringing decorative lighting to an ordinary consumer object, a shampoo bottle, without having to alter the consumer object.

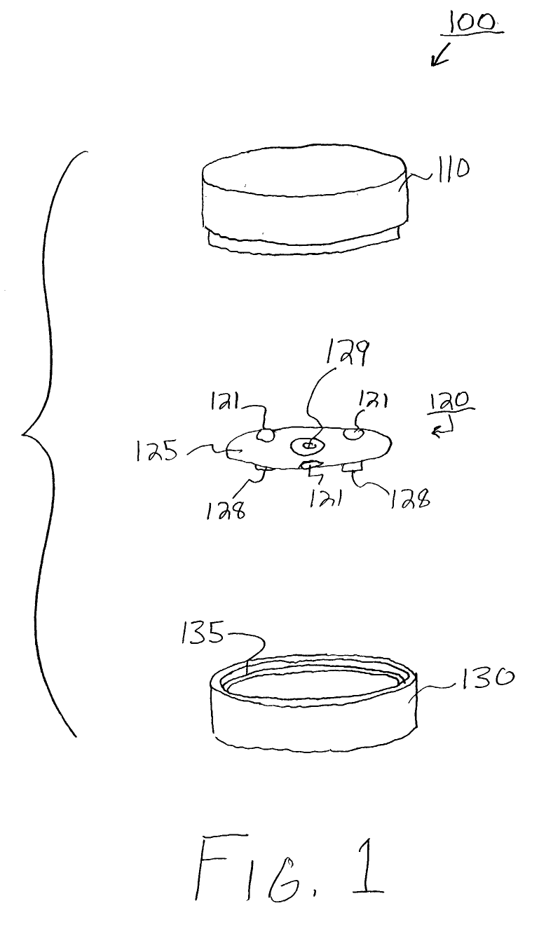

FIG. 1 depicts the parts of a light chip according to a preferred embodiment of the present invention. The light chip 100 is comprised of a top section 110, a middle (inside) section 120, and a bottom section 130. The top and bottom sections 110 and 130 are made of a transparent material, such as clear plastic, and when fixed to each other these sections effectively fluid-tightly seal middle section 120 inside light chip 100. Middle section 120 is comprised of three (by way of example) LEDs 121 which are located about the circumference of the oval-shaped middle section 120. Although LEDs are used in the preferred embodiment, any illuminable light source, such as an incandescent light bulb, may be used in accordance with the invention.

In the preferred embodiment, the LEDs 121 are placed at or proximate the containment rim or edge of the body 125 of middle section 120, rather than on one of the two sides or faces of body 125, so that no matter what the orientation of the chip within the liquid container, the light of the three LEDs 121 will not be blocked by body 125 of middle section 120. Body 125 may be a miniature wiring board. In the preferred embodiment, the LEDs 121 are powered by two button battery cells 128, specifically two PCS AGS batteries. However, any means for providing power to the LEDs 121 which can also fit within the light chip may be used. For example, photovoltaic cells, a means responsive to a wireless signal generated outside the light chip, or a means for translating kinetic energy into electrical power, could be used.

In the preferred embodiment, the top and bottom sections 110 and 120 are fixed together by friction. Specifically, an oval-shaped protrusion 115 whose circumference is slightly less than the circumference of the oval cross-section of top section 110 is formed in the bottom of top section 110. A matching oval-shaped depression 135 or hole is formed in the bottom section 130. Protrusion 115 fits into depression 135 to form the friction seal between the two sections. An adhesive or sealant can then also be applied to the joint to assure continued fluid-tightness. Other embodiments may use other means of fixing the top and bottom sections 110 and 130 to each other and sealing in middle section 120. For example, the sections may be threaded, grooved, and/or glued together.

The long axis of the oval-shaped top and bottom sections 110 and 130 is roughly 27 mm, while the height of the light chip (when assembled) is roughly 26 mm, in the preferred embodiment shown in FIG. 1. This is a good size for placement in many liquid containers; however, other embodiments of the light chip may be much smaller or much larger, depending on their intended usage. Furthermore, the light chip may take a variety of shapes, such as a round ball, spherical, cylindrical, cubical, as well as mimicking the shape of other objects, such as the Statue of Liberty, a book, etc.

Although the preferred embodiment has three LEDs, other embodiments can have any number of LEDs. The LEDs may be in any color, and are preferably of various different colors in a single light chip, and can operatively be illuminated following any pattern. Preferably, each of LEDs 121 blink or are cycled on and off randomly or intermittently, causing a scintillating effect in the liquid in which the light chip is placed. The different LEDs 121 may be colored differently to increase the effect. Other embodiments may have the LEDs light up in a predetermined pattern, remain continually lit, light up in a random manner, or turn on and off for varying lengths of time. A converted integrated circuit for controlling the on-off illumination of the LEDs may be included in the light chip. In one preferred embodiment, a vibration switch 129 located in the center of body 125 detects any motion, of the light chip, and separately or concurrently turns on LEDs 121 (or initiates a timed illumination cycle of the LEDs under the control of an electrical circuit) when motion is detected. Any type of actuator may be used in various embodiments of the present invention, such as a sensor responsive to a predetermined condition or stimulus, a timer, a randomizing actuator, a receiver responsive to a wireless signal, etc.

In general, it is preferable for the LEDs 121 to not be continuously lit, so that batteries 128 are not quickly exhausted (this will be less of a problem in embodiments using photovoltaic cells as a power source). In addition, it is contemplated that some embodiments have an initiation means for starting the functioning of the light chip. Consumer items such as cosmetics or potable liquids may be stored on a shelf for relatively long periods of time before the consumer purchases them. Unless the lighting effect is being used to entice the consumer to buy the product, any functioning of the LEDs 121 while the liquid container is still in transmit to or on the shelf in a retail store would be a waste of power. In those cases, an initiation means would be used by the consumer to activate the light chip after purchasing the consumer item. For example, a “shake-to-activate” motion sensitive switch could be used to initially activate the light chip for further use.

A light chip according to the present invention may be placed inside a liquid container to float freely in the contained liquid, or to otherwise move freely about the interior of the container (such as along the container bottom or wall(s) under the force of gravity), may be affixed to an interior wall or portion of the liquid container, or may be restrained or captured by some means to a portion of the liquid container for movement within a predetermined limited region or space. The liquid container may be a bottle, a jar, a vial, a (cosmetic) compact, etc., of any shape or size. The liquid contained in the container may itself be a potable fluid (such as water or soda), cologne or perfumery, lip gloss, nail polish, gelatin, or any fluid or semi-fluid (e.g., gel or fine powder) that is sufficiently translucent for the light chip to cause a visible effect. The liquids can have a wide range of viscosities, from those that flow as freely as water to relatively thick or viscous pastes or gelatins.

Although preferable, the liquid container does not necessarily have to be sufficiently translucent for the light chip to cause a visible effect. For example, one contemplated form of the present invention provides an entirely opaque vial of lip gloss with one or more light chips placed in the bottom of the vial so that the user would see the light effects through the lip gloss when the vial is open and the user is presumably using or accessing the lip gloss. In addition, the liquid container may be semi-opaque. For example, in a liquid container made of light white plastic, the light chip itself may be unseen, but the light effect caused by the LEDs of light chip can illuminate the walls of the liquid container. This effect can be further heightened where the lighting pattern is random and the LEDs are colored.

Exemplary embodiments are described below. The invention is not however intended to be limited by these embodiments which are presented by way of example and can be modified in various ways within the scope of protection defined by the appended patent claims.

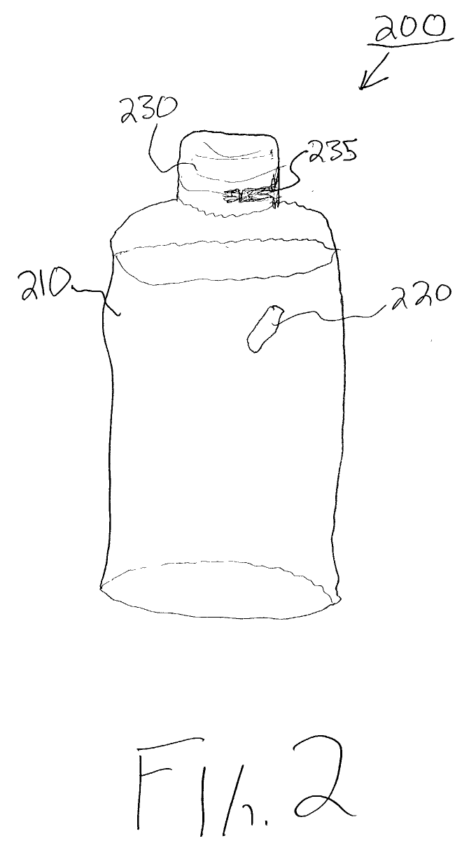

FIG. 2 shows a cross-section of a first exemplary embodiment according to the present invention. In FIG. 2, a bottle 200 contains a semi-viscous fluid 210 with a light chip 220 floating therewithin. In this embodiment, a protrusion 235 in the neck 230 of bottle 200 blocks unintended escape or egress by light chip 220 when the fluid contents 210 of bottle 200 are poured out. Such a blocking protrusion may or may not be necessary, depending on the liquid contents in the container. For instance, if it is a container of potable liquid, such as apple juice, a blocking means is preferred to ensure that a person drinking the apple juice does not choke on the light chip, or swallow it. Such a blocking structure may take any form, or may be a natural by-product of the liquid container's design, i.e., the neck of the a bottle may be too small to allow the light chip to pass. In that case, the light chip may be initially inserted as part of the manufacturing or bottling process. On the other hand, for a container of hand or face cream, a blocking structure would not be likely necessary.

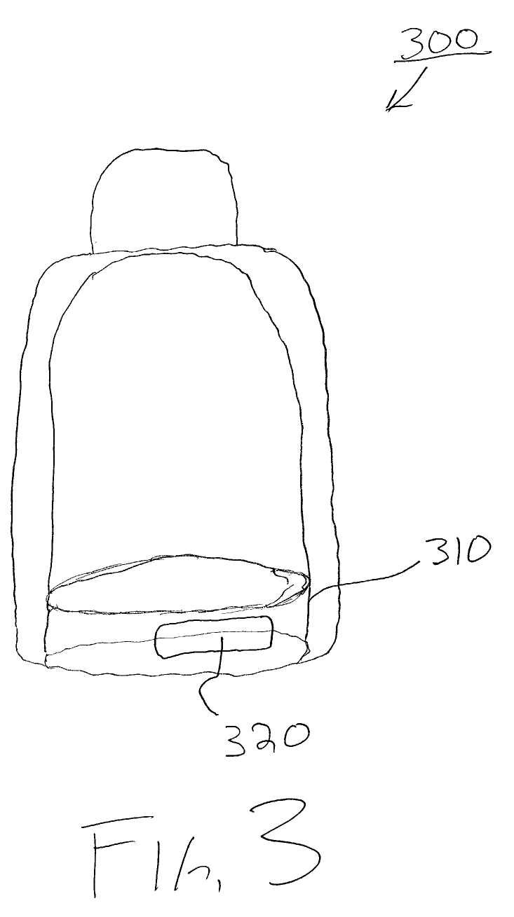

FIG. 3 shows a cross-section of a second exemplary embodiment according to the invention. In FIG. 3, a bottle 300 has a compartment 310 defined in its bottom. A light chip 320 is inserted and sealed in this bottom compartment 310. Any means of connecting the bottom compartment 310 to the bottle 300 may be employed, such for example, as frictional or snapable engagement using a detent and notch. There may be sufficient room within compartment 310 to allow light chip 320 to freely move horizontally within the compartment, thereby adding to the decorative lighting effect by providing for random variation in the location and effect of the light. Compartment 310 may also be filled with a fluid so as to slow down the lateral movement of light chip 320 within compartment 310. This fluid will also prevent the light chip from simply bouncing from one side of the compartment to the other. In other embodiments, the light chip may be positively fixed within compartment 310, in which case the LEDs may be placed on or along or proximate the upper surface of the light chip so that the light is directed upward into the container.

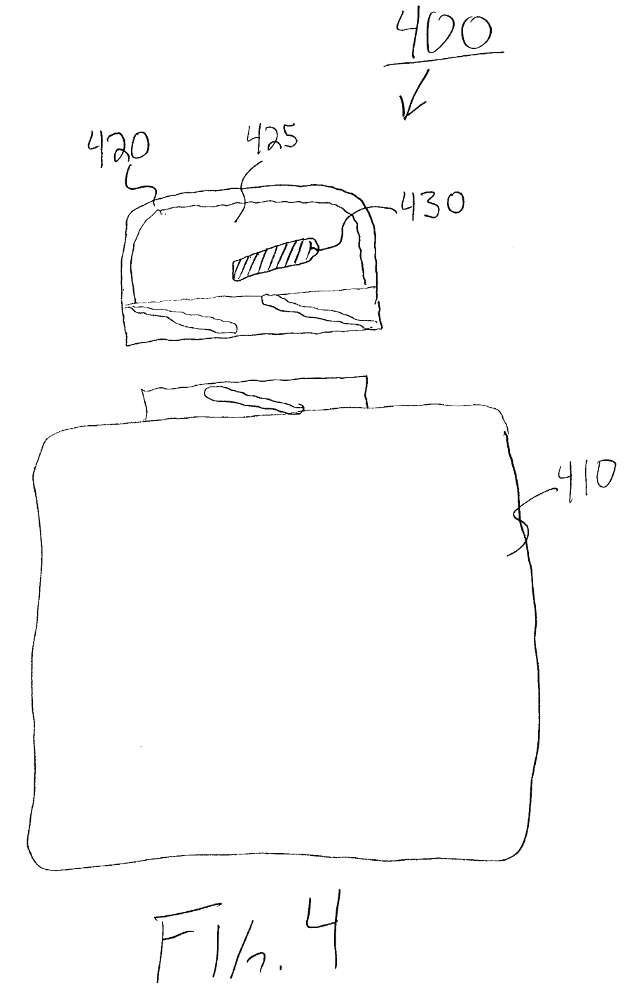

FIG. 4 shows a cross-section of a third exemplary embodiment according to the present invention. In FIG. 4, ajar 400 is comprised of a container section 410 and a cap 420 which is screwed into the container section 410 in order to seal the contents within. Cap 420 contains a hollow space 425 in which light chip 430 is captively disposed. As in the second exemplary embodiment, light chip 430 may freely move within hollow space 425; however, in the FIG. 4 embodiment, light chip 430 can move both vertically and horizontally within hollow space 425. Also hollow space 425 may be filled with a viscous fluid for enhanced aesthetic effect.

In FIG. 4, either the top 427 of cap 420, the bottom 423 of cap 420, or both may be translucent, depending on the desired effect. If only top 427 is translucent, the light effect produced by light chip 430 can be directly viewed. If only bottom 423 is translucent, the light chip 430 will not be visible, but the light pattern produced in the fluid within container section 410 will be apparent.

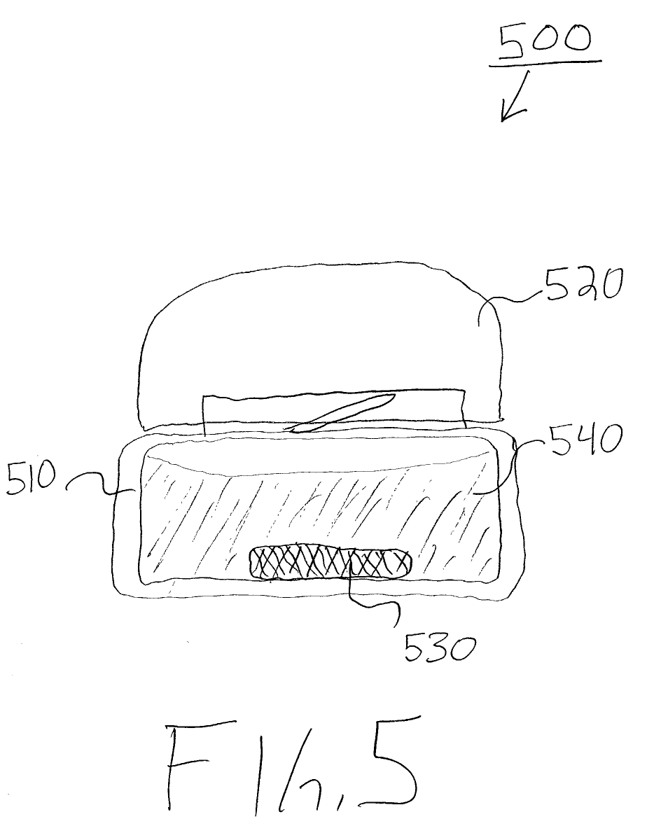

FIG. 5 shows a cross-section of a fourth exemplary embodiment according to the present invention. In FIG. 5, lip gloss case 500 has a container portion 510 and a top 520 which screws onto container portion 510. Lip gloss is, of course, an illustrative fluid and the contents of such a case could be anything from hand cream to rouge to butter. Light chip 530 is placed in the bottom of container portion 510 submerged underneath lip gloss 540. In this embodiment, the walls of container portion 510 may or may not be translucent, depending on the intended illumination effect.

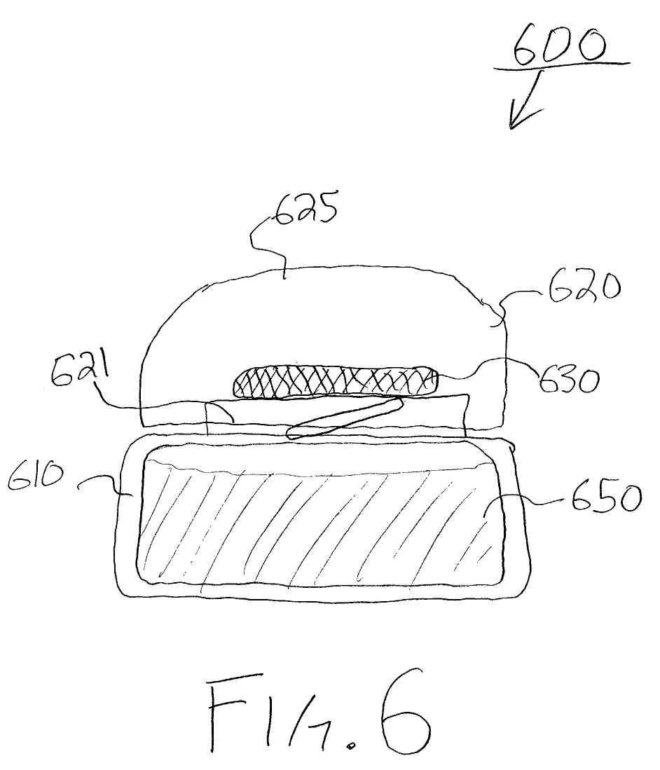

FIG. 6 shows a cross-section of a fifth exemplary embodiment according to the present invention. In FIG. 6, similarly to FIG. 5, lip gloss case 600 has a container portion 610 and a cap 620 which is screwed onto container portion 610. Light chip 630 is secured within cap 620 which has a translucent top surface 625 through which the LEDs of the light chip may be seen. If the bottom 621 of cap 620 and the walls of container portion 610 are translucent, light chip 630 will create a light display within lip gloss 650.

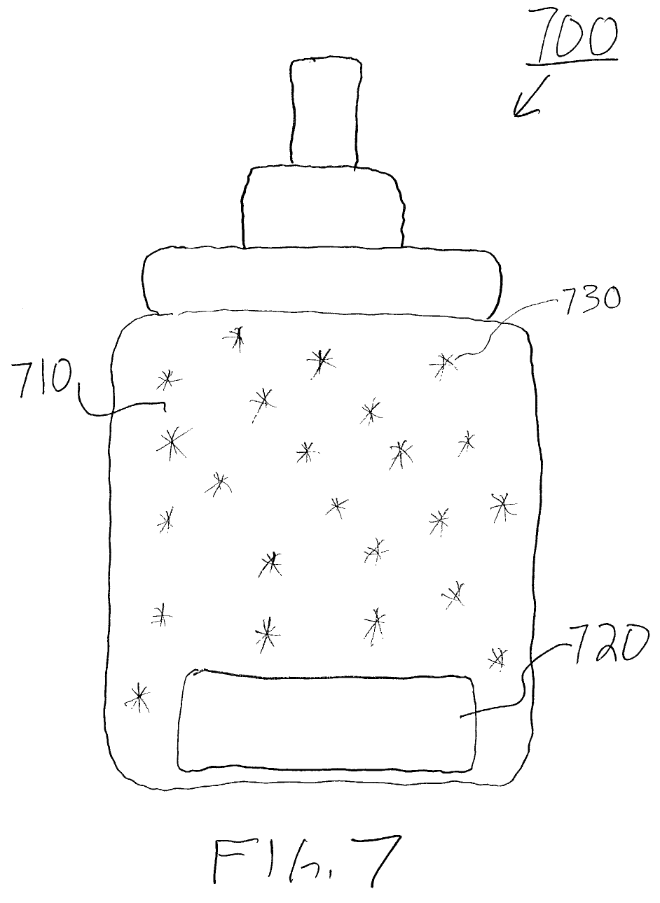

FIG. 7 shows a cross-section of a sixth exemplary embodiment according to the invention. In FIG. 7, a bottle 700 contains a gelatinous fluid 710 which contains light chip 720 affixed (by way of example) to the bottom. Glitter 730 is suspended throughout the gelatinous fluid 710. Glitter 730 shimmers when light from the light chip is reflected from the individual particles. Preferably, light chip 720 is activated by a motion switch, thereby causing an illumination effect within bottle 700 when it is shaken.

As FIG. 7 suggests, the present invention can also be used as part of a toy or game.

As the above exemplary embodiments demonstrates, the present invention can be used by a manufacturer to add an interesting and engaging illumination effect to a pre-existing liquid container without altering the liquid container, or it can be easily integrated into the liquid container itself during the manufacturing process. Unlike the prior art, a light chip according to the present invention may be easily integrated into a container without requiring an unreasonable alteration of the manufacturing process.

Thus, while there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. In a container having an outer wall and containing a liquid, a module operable for creating an illumination effect in the contained liquid for enhanced visual appearance of the liquid-containing container, said module comprising:
a module housing disposed within the container and defining a closed, fluid-tightly sealed interior space so as to prevent the contained liquid from entering the interior space;
a plurality of illuminators disposed in said housing space and each electrically actuatable to generate light;
a controller in the housing space and connected to the plural illuminators for selectively actuating each of the plural illuminators and thereby causing the module to emit light from the illuminated actuators and into and through the contained liquid for viewing by a user of the container through the container wall; and
means in said housing space for delivering to the controller and plural illuminators an electric current for generating light from each illuminator when the each illuminator is actuated by said controller to thereby create a visually appealing illumination effect as light generated by the actuated illuminators is carried through the contained liquid for viewing through the container wall by a user of the container.

2. In a container in accordance with claim 1, wherein each of the plural illuminators emits light of a different color and wherein the plural illuminators are individually actuatable by the controller to create seemingly random patterns of variously-colored light operatively emitted from the module, and wherein said means comprises an electric power source located within the housing space.

3. In a container in accordance with claim 2, wherein said controller is operable for actuating each of the plural illuminators for different illumination times.

4. In a container in accordance with claim 2, wherein the module further comprises an actuator in said housing space and connected to said controller, said actuator being operable to initiate operation of said controller to actuate said plural illuminators and thereby create multi-colored illumination effects from said module initiated by operation of said actuator.

5. In a container in accordance with claim 4, wherein said actuator is operable in response to motion of the actuator resulting from motion of the module within the container.

6. In a container in accordance with claim 5, wherein said controller is operable, in response to said actuator, to selectively illuminate the plural illuminators for a period of time during which the illuminators are individually actuated to create the multi-colored illumination effects from said module during the period of time.

7. In a container in accordance with claim 2, wherein said controller is operable for actuating each of the plural illuminators to cause the each illuminator to intermittently power on and off for at least a predetermined period of time.

8. In a container in accordance with claim 2, wherein the illuminators are light emitting diodes, and wherein the electric power source comprises a battery.

9. In a container in accordance with claim 1, wherein the module is disposed and constructed so that the module freely floats within the contained liquid.

10. In a container in accordance with claim 1, wherein the module is disposed within the container and within the contained liquid for movement of the module within the container as the container is moved and reoriented by a user of the container.

11. In a container in accordance with claim 1, wherein the container comprises an interior container compartment and wherein the module is disposed within the container compartment for restricting movement of the module into interior portions of the container other than the container compartment.

12. A light chip for decoratively illuminating a container of liquid comprising:
at least one light source;
at least one energy source providing energy to the at least one light source;
an actuator for switching the at least one light source on and off;
an initiation means for initiating the functioning of the at least one light source, wherein the at least one light source will not turn on until said initiation means is activated; and
a translucent casing having a liquid-tight seal containing said actuator, said at least one light source, and said at least one energy source;
wherein the light chip is one of placed inside the liquid container to float freely in the contained liquid, affixed to a portion of the container, or restrained by some means to a portion of the container where it may move freely.

13. The light chip for decorative illumination of claim 12, wherein the at least one light source comprises at least one light emitting diode (LED).

14. The light chip for decorative illumination of claim 12, wherein the at least one energy source comprises at least one of a battery and a photovoltaic cell.

15. The light chip for decorative illumination of claim 12, wherein the actuator and the initiation means are the same.

16. The light chip for decorative illumination of claim 12, wherein the actuator comprises at least one of a sensor responsive to a predetermined condition or stimulus, a timer, a randomizing actuator, and a receiver responsive to a wireless signal.

17. The light chip for decorative illumination of claim 12, wherein the actuator switches the at least one source on and off in a predetermined pattern, in a random pattern, or in response to stimuli.

18. The light chip for decorative illumination of claim 12, wherein the container has a bottom compartment and a viscous fluid filling the space in the bottom compartment, and wherein the light chip is suspended within said viscous fluid and moves freely within it.

19. The light chip for decorative illumination of claim 12, wherein the light chip is placed in an off-the-shelf consumer product container and wherein the off-the-shelf consumer product container contains potable fluid, cologne or perfumery, lip gloss, nail polish, or a gelatinous fluid product.

20. A method for manufacturing a liquid container, comprising the step of:
at least one of a) placing a light chip inside the liquid container to float freely in the contained liquid, b) affixing the light chip to a portion of the container, or c) placing the light chip in a portion of the container within which the light chip may move freely;
wherein the light chip is comprised of:
at least one light source;
at least one energy source providing energy to the at least one light source;
an actuator for switching the at least one light source on and off;
an initiation means for initiating the functioning of the at least one light source, wherein the at least one light source will not turn on until said initiation means is activated; and
a translucent casing having a liquid-tight seal containing said actuator, said at least one light source, and said at least one energy source.
